(19) United States
(12) Patent Application Publication
(10) Pub. No.: US 2008/0050525 A1
(43) Pub. Date: Feb. 28, 2008

(54) Mechanical stability enhancement by pore size connectivity control in colloidal crystals by layer-by-layer growth of oxide

(76) Inventors: Hernan Miguez, Valencia (ES); Geoffrey Alan Ozin, Toronto (CA); San Ming Yang, Toronto (CA); Nicolas Tetreault, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/878,023

(22) Filed: Jul. 20, 2007

Related U.S. Application Data
(62) Division of application No. 10/255,578, filed on Sep. 27, 2002, now abandoned.

(51) Int. Cl. B05D 3/04

(52) U.S. Cl. 427/301

(57) ABSTRACT

The present invention provides a method to control the degree of connectivity of the colloidal particles making up a colloidal crystal and, consequently, the pore size, filling fraction, mechanical stability and optical properties of the colloidal lattice, without disrupting its long range order and without the deleterious effects of lattice contraction induced cracking observed in conventional necking methods based on thermal sintering. The colloidal particles are connected to adjacent colloidal particles in the lattice by a homogeneous layer of uniform and controllable thickness of a metal oxide. This metal oxide layer is grown in a layer-by-layer process and is chemically bonded to the colloidal particle surface and serves to enhance the mechanical stability of the colloidal crystal in addition to acting to control the pore size or void volume between the colloidal particles in the lattice.

### FIELD OF THE INVENTION

The present invention relates to a method of enhancing the mechanical stability in colloidal crystals through pore size and connectivity control using layer-by-layer growth of metal oxide layers on the micro-particles constituting the colloidal crystal.

### BACKGROUND OF THE INVENTION

Colloidal crystals have attracted the attention of researchers in numerous fields such as ceramics, photonics, chemical sensing and membranes. The pore size and the connectivity of the lattices of these colloidal crystals are important parameters that largely affect their mechanical and optical properties as well as the diffusion of fluids through them. The approach generally employed to increase the connectivity of colloidal crystals, is based on the sintering of the particles from which they are made. In order to do so, lattices are subjected to thermal annealing at temperatures between 700° C. and 1100° C. This treatment induces the softening of the silica and the occurrence of viscous mass flow processes, which, eventually, will provide mass continuity to the structure and decrease the pore size, which can be gradually varied with the sintering temperature, see M. D. Sacks, T. Y. Tseng, J. Am. Ceram. Soc. 1984, 67, 526. A contraction of the center-to-center distance between the particles is also observed.

The ability to control the optical, mechanical and surface properties of three dimensional colloidal lattices is of fundamental importance to put into practice the many predicted applications of these materials, some of the most promising ones belonging to the field of photonic crystals, see E. Yablonovitch, Phys. Rev. Lett. 1987, 58, 2059. Among the different uses that colloidal crystals have found in this field, the utilization of them as sacrificial templates to infiltrate high dielectric constant semiconductors to realize full photonic band gap materials has been particularly successful. Briefly, the void space of a face centered cubic (fcc) lattice of colloidal silica spheres, which can be obtained by different methods, is infiltrated with a high dielectric constant material such as silicon or germanium. Finally, silica is removed by an acid etching process leaving behind a face centered cubic close packed lattice of air cavities in a semiconductor background.

Prior to infiltration, mass continuity between the spheres of the template is required. Not only will this provide the necessary mechanical stability to stand the infiltration process but also will allow the etching solution to flow through the entire crystal when dissolving the silica. Furthermore, the opening of a full photonic band gap is extremely sensitive to the size of the windows interconnecting the air cavities in the inverted structure, (see K. Busch, S. John. Phys. Rev. E 1998, 58, 3896) which is determined by the degree of interpenetration of the spheres in the template. So far, the connectivity of the silica lattice has mainly been controlled by sintering, see R. Mayoral, J. Requena, J. S. Moya, C. López, A. Cintas, H. Míguez, F. Meseguer, L. Vázquez, M. Holgado, A. Blanco. Adv. Mater. 1997, 9, 257. Thermal annealing between 700° C. and 1100° C. gives rise to viscous mass flow processes, which eventually result in different degrees of necking between neighboring particles. The effect of this treatment on the structure and photonic crystal properties of silica colloidal photonic crystals has been thoroughly studied, see H. Míguez, F. Meseguer, C. López, A. Blanco, J. S. Moya, J. Requena, A. Mifsud, V. Fornés, Adv. Mater. 1998, 10, 480. Water desorption, silanol condensation, changes in porosity and mass flow give rise to a contraction of the lattice constant and a modification of the refractive index of the silica particle, both of which depend strongly on the temperature. All these processes lead to a highly interconnected hydrophobic lattice that is suitable to be used as a template for infiltration of compounds at high pressures and temperatures.

Excellent results have been obtained for free standing sintered silica colloidal photonic crystals templates obtained by sedimentation. However, major drawbacks are found when the filling fraction of substrate supported silica colloidal photonic crystals, either planarized (P. Jiang, J. F. Bertone, K. S. Hwang, V. L. Colvin, Chem. Mater. 1999, 11, 2132) or confined (S. M. Yang, H. Miguez, G. A. Ozin. Adv. Funct. Mat 2002, 12, 425) needs to be controlled by sintering. While the sintering process occurs, the induced contraction of the lattice is opposed by the strong interaction between the substrate and the particles. This results in the appearance of cracks all over the crystal. Hence, control of the filling fraction of the template is not possible by sintering without largely reducing the quality of the sample. Furthermore, only high temperature resistant substrates, like quartz or silicon, are suitable for this kind of treatment.

Therefore it would be very advantageous to provide a method to accurately control the degree of connectivity of the silica particles, pore size, filling fraction, optical properties and mechanical stability of the silica colloidal photonic crystal.

### SUMMARY OF THE INVENTION

The present invention provides a generic method to control the pore size and increase the connectivity and enhance the mechanical stability of colloidal crystals. Accurate control of the coating thickness and, therefore, pore size is achievable by this procedure.

In one aspect of the present invention there is provided a method of structurally stabilizing a colloidal crystal lattice and controlling pore size therein, the colloidal crystal being formed from substantially micro-particles each having a surface to which water can be hydrogen bonded, the method comprising the steps of:

a) exposing the colloidal crystal lattice to water vapor so that water is hydrogen bonded to the surfaces of the micro-particles;

b) infiltrating into the colloidal crystal lattice a reactive fluid containing a metal atom M for an effective period of time, the reactive fluid being reactive in the presence of water, wherein said effective period of time is sufficient so that the hydrogen bonded water reacts with the reactive fluid to form a continuous metal oxide layer on each micro-particle in the lattice; and

c) repeating steps a) and b) a pre-selected number of times to give a metal oxide layer on the micro-particles with a pre-selected thickness so that the metal oxide layer deposited on the surface of adjacent micro-particles overlaps thereby providing mass continuity between neighbouring micro-particles to structurally stabilize the colloidal crystal lattice and control the pore size in the colloidal crystal lattice between the micro-particles.

In this aspect of the invention the micro-particles may be substantially mono-disperse micro-spheres and the reactive fluid may be a reactive gas.

In another aspect of the present invention there is provided a structurally stabilized colloidal crystal formed from micro-particles with controlled pore sizes therein, the colloidal crystal being formed by a process comprising the steps of:

a) producing a colloidal crystal lattice from micro-particles with the micro-particles having a surface to which water can be hydrogen bonded;

b) exposing the colloidal crystal lattice to water vapor so that water is hydrogen bonded to the surface of the micro-particles; then

c) infiltrating into the colloidal crystal lattice a reactive fluid containing a metal atom M for an effective period of time, the reactive fluid being reactive in the presence of water, wherein said effective period of time is sufficient so that the water in the layer of hydrogen bonded water reacts with the reactive fluid to form a continuous metal oxide layer on each micro-particles in the lattice; and

d) repeating steps b) and c) a pre-selected number of times to give a metal oxide layer on the micro-spheres with a pre-selected thickness so that the metal oxide layer deposited on the surface of adjacent micro-particles overlaps thereby providing mass continuity between neighboring micro-particles to structurally stabilize the colloidal crystal lattice and control the pore size in the colloidal crystal lattice between the micro-particles.

In this aspect of the invention the micro-particles may be mono-disperse micro-spheres and the reactive fluid may be a reactive gas.

The present invention also provides a colloidal crystal comprising substantially mono-disperse micro-spheres of diameter between about 200 nm and about 5000 nm, ordered in a three dimensional lattice in which adjacent micro-spheres are connected by a uniform metal oxide layer of pre-selected thickness grown on the surface of the colloidal micro-spheres after the three dimensional lattice is grown.

### BRIEF DESCRIPTION OF THE DRAWINGS

The method to control the pore size and increase the connectivity and mechanical stability of colloidal crystals in accordance with the present invention will now be described, by way of example only, reference being made to the accompanying drawings, in which:

FIG. 1 shows an example of an apparatus used to grow multiple layers on the surface of micro-particles constituting a colloidal crystal for increasing mechanical stability and controlling pore size in the colloidal crystal;

FIG. 2 shows a diagram modelling the first two steps in the cycling process of exposure of the colloidal lattice to water vapour and a reactive gas;

FIG. 3 shows high magnification scanning electron microscopy (SEM) images of the surface of an actual colloidal crystal before and after being treated with SiCl₄ gas in which the necking layer of silica grown on each of the micro-spheres which joins between neighboring spheres can be clearly observed, as well as the reduction of pore size;

FIGS. 4(a) to 4(d) are scanning electron micrographs (SEM) showing a planarized colloidal crystal made of 320 nm diameter silica micro-spheres after being infiltrated with the reactive gas containing silicon and water vapor in several deposition cycles performed so that the external pores of the final sample were occluded, in which FIG. 4(a) shows a cleaved edge showing that the layer-by-layer growth process does not disturb the long-range order of the structure, FIG. 4(b) shows the detail of the external surface, FIG. 4(c) shows the detail of a cleaved edge corresponding to a (111) plane of the structure, and FIG. 4(d) shows the same as FIG. 4(c) for a (100) plane;

FIG. 5 shows optical reflectance spectra of a planarized colloidal crystal prior to silica infiltration (solid line) and after 1 and 2 cycles of layer-by-layer silica infiltration by water vapour and the reactive gas (SiCl₄) (dotted and dashed lines, respectively);

FIG. 6 shows optical transmission spectra of a planarized colloidal crystal before (top) and after 2, 4, and 6 cycles of exposure to water vapor and reactive gas (SiCl4) (from bottom to top, respectively) according to the method of the present invention;

FIG. 7 are plots of Young Modulus and Hardness of a colloidal crystal after be processed according to the method disclosed herein showing quantitatively the large enhancement of the mechanical stability of the planarized silica colloidal crystal after being undergoing a different number of cycles of exposure to H₂O and SiCl₄; and

FIG. 8 shows SEM and optical micrographs comparing the effect of sintering at around 700 degrees Celsius (left column) and that of treating with H₂O and SiCl₄ growth cycles on three different confined and planarized silica colloidal crystals (right column).

### DETAILED DESCRIPTION OF THE INVENTION

The present invention describes a material made of colloidal particles ordered in a three dimensional lattice (colloidal crystal) in which the colloidal particles are connected to adjacent colloidal particles in the lattice by a homogeneous layer of uniform and controllable thickness of an arbitrary material chosen among the group of oxides. This layer, is grown in a layer-by-layer process described hereinafter and is chemically bonded to the colloidal particle surface and serves to enhance the mechanical stability of the colloidal crystal built of these particles in addition to acting to control the pore size or void volume between the colloidal particles in the lattice.

The present invention provides a method to control the degree of connectivity of the colloidal particles making up the colloidal crystal and, consequently, the pore size, filling fraction, mechanical stability and optical properties of the colloidal lattice, without the deleterious effects of lattice contraction induced cracking observed in conventional necking methods based on thermal sintering. An important contribution of the present invention is to provide a method of necking of colloidal particles in a lattice preventing the cracking of the structure, which is a major drawback when planarized or confined colloidal crystals are thermally annealed.

The method involves alternating infiltration of water vapor and a reactive fluid containing a metal atom M (such as Si, Ge, Sn, or Ti) into the colloidal crystal at room temperature and atmospheric pressure. This reactive fluid, preferably a reactive gas or vapor, is deposited on the hydrophilic surface of the colloidal spheres. Reaction of this reactive gas with surface chemisorbed-physisorbed water and hydrolytic polycondensation of the newly formed surface species yields a uniform layer of metal (M) oxide of controlled thickness on top of each sphere, which provides mass continuity between neighboring particles. Later exposure to water vapor creates a new layer of physisorbed or chemisorbed water which allows one to repeat this process until the desired metal oxide coating thickness-optical properties-pore size-mechanical properties are achieved. The modifications of the colloidal crystal features caused by these structural changes are analyzed by SEM, nano-indentation and optical reflectance and transmittance, the latter being analyzed in terms of simple Bragg models that allow estimation of the pore size (filling fraction) of the sample by using analytical expressions.

Further, this coating layer presents a high surface density of metal hydroxyl groups which confers a hydrophilic character to this surface. This, in turn, makes it susceptible of being functionalized with different organic or inorganic groups so as to modify the physico-chemical features of the surface in a controlled way.

In the case where the reactive fluid phase is a liquid, a slow condensation from the gas phase or a non abrupt infiltration are needed to prevent the disruption of the original lattice in the first necking treatment. After that, and independently of the phase of the reactive fluid employed in that first treatment, since it provides an enhancement of the mechanical stability of the colloidal lattice, a liquid phase could be employed for next coating growth without taking these precautions.

The present invention will now be illustrated by way of the following non-limiting example in which the colloidal crystal is produced using silica micro-spheres.

### EXAMPLE 1

As an example of the invention disclosed herein, this example shows the method to control the pore size and optical properties and, at the same time, increase the connectivity and, in particular, the mechanical stability of planarized silica (SiO₂) colloidal crystals. In this case, the metal containing gas reactant is silicon tetrachloride and the metal atom is M=Si and the oxide species to deposit upon and coat the colloidal particles is SiO₂. Deposition of silicon tetrachloride (SiCl₄, M=Si), followed by reaction with water hydrogen bonded to the micro-sphere surface, is performed at room temperature and atmospheric pressure to coat the micro-sphere lattice with a continuous layer of silica (SiO₂). Data will then be presented showing evidence of the accurate control of the coating thickness and, therefore, pore size and the enhancement of the mechanical stability achievable by this procedure.

The planarized colloidal crystal was prepared as follows. Firstly, mono-dispersed suspensions of colloidal silica particles of diameter between 200 and 400 nm were prepared following the Stöber method as disclosed in W. Stöber, A. Fink, E. Bohn. J. Colloid Interface Sci., 1968, 26, 62. After that, the particles were crystallized by convection induced self-assembly using a glass slide or a silicon wafer as substrates, as described in the literature, see J. F. Bertone, P. Jiang, K. S. Hwang, D. M. Mittleman, V. L. Colvin. Phys. Rev. Lett. 1999, 83, 300. Colloidal lattices prepared in such a way present interesting photonic crystal properties and applications, see J. F. Bertone, P. Jiang, K. S. Hwang, D. M. Mittleman, V. L. Colvin. Phys. Rev. Lett. 1999, 83, 300, and Y. A. Vlasov, X-Z Bo, J. C. Sturm, D. J. Norris. Nature 2001, 414, 289. However, they cannot be sintered without strongly disturbing the order of the lattice. In addition, in some cases, the low thermal stability of the substrate does not even allow thermal annealing of the colloidal lattice. For these reasons, these structures are particularly interesting for checking the applicability of the method presented herein.

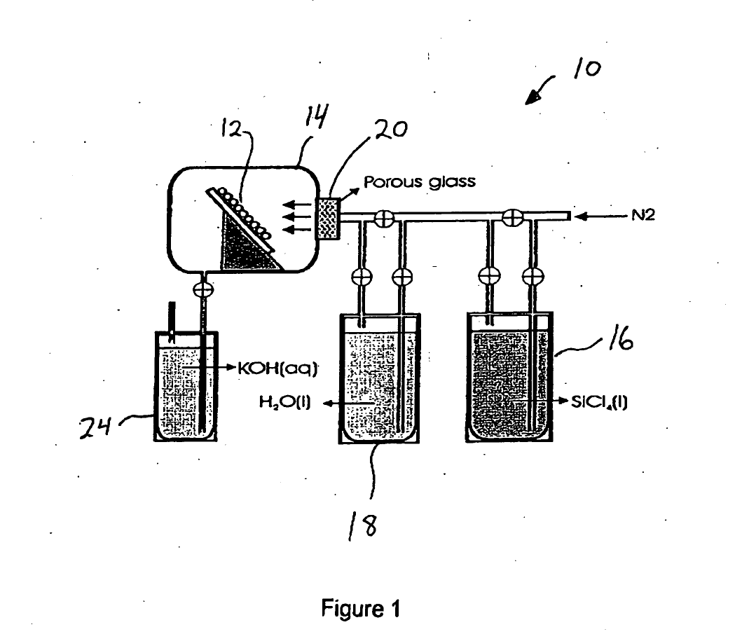

The silica infiltration and deposition is performed at atmospheric pressure and room temperature and may be made using an apparatus such as the one shown at 10 in FIG. 1. Silica colloidal crystals 12 made by the above synthetic routes were placed in a chamber 14 through which silicon tetrachloride (SiCl₄) from a storage container 16 and water vapor from a water storage container 18 were alternately flowed into the chamber 14 holding the colloidal crystal in order to form silica layers of controlled thickness upon the surface of the microspheres in the silica colloidal crystal. Pure N₂ gas is first flowed to remove the excess of water from the surfaces of the colloidal crystal and to leave only the water that is strongly bonded to the surface ≡Si—OH groups. SiCl₄(l) is placed in a bubbler through which the N₂(g) stream is then flown. This flow transports the reactive species to the reactor where the colloidal crystals are located.

A porous glass septum 20 placed between the bubbler and the chamber 14 favours the homogeneity of the reactive gas in the sample compartment. Reaction between the SiCl₄ molecules and the surface bonded water takes place thereby generating HCl, which functions to catalyze the hydrolytic polycondensation process between the so formed ClₓSi(OH)₄₋ₓ species. This leads to the formation of condensed ≡Si—O—Si≡ units, which lead to the formation of the silica layer grown on top of the microspheres. This silica presents new surface ≡Si—OH groups capable of hydrogen bonding to water. Then re-hydration of the microsphere surface is attained, by flowing dry N₂ through the bubbler, containing water. Water vapor is taken to the sample chamber where it bonds to the surface silanol groups of the microspheres. This strongly bonded surface water, hydrogen bonds to other water molecules and, eventually, a layer of water is created around the microspheres. At the end of the line, a trap 24 (FIG. 1) consisting of a concentrated aqueous solution of a base (such as KOH, for example) is placed to neutralize the HCl generated in the coating process as well as the remaining SiCl₄.

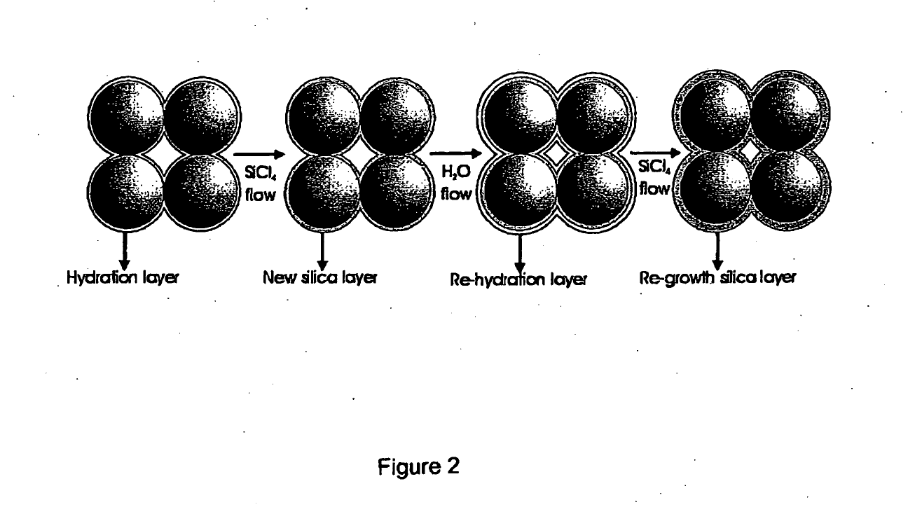

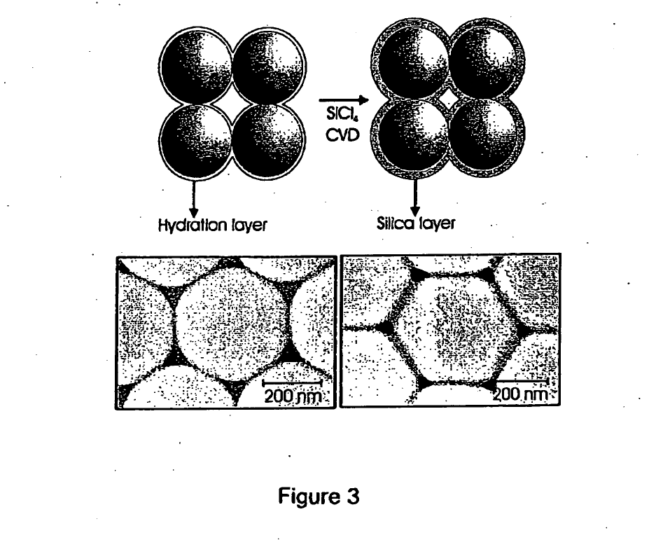

FIG. 2 shows a diagram of the first two steps in the cycling process of exposure of the colloidal lattice to water and the reactive gas containing silicon. FIG. 3 shows high magnification SEM images of a detail of the surface of a planarized silica colloidal crystal before and after being treated. The necking layer of silica grown on each of the micro-spheres, which joins between neighboring spheres to stabilize the crystal, can be clearly seen.

While silicon tetrachloride is the preferred reactive gas containing silicon to use, it will be appreciated that other reactive gases containing silicon that hydrolyse to silica may be used including but not limited to other silicon tetrahalides like silicon tetrabromide, halosilanes like trichlorosilane, tetraalkoxyorthosilicates like tetramethoxyorthosilicate and alkoxyhalosilanes like methoxytrichorosilane. It will also be appreciated that other reactive gases may be used that contain elements other than silicon and can be hydrolysed by water on the surface of the silica micro-spheres to a material such as a metal oxide, which can coat the silica micro-sphere colloidal crystal in a layer-by-layer fashion and that after infiltration of the necked colloidal crystal with another material can be removed to create the inverted replica material, including but not limited to germanium tetrachloride and titanium tetrachloride.

Further it will be appreciated that the method described in the invention is not restricted to the use of colloidal crystals made of silica micro-spheres and can be applied to colloidal crystals comprising micro-particles of other compositions such as polymer micro-spheres, including but not limited to polystyrene micro-spheres and reactive gases containing silicon including but not limited to silicon tetrachloride. The micro-spheres used to produce the lattice may preferably have a diameter in a range from about 100 nm to about 5000 nm. When micro-particles are used which do not bind water on the outer surface of the particles, an initial step may be performed of depositing an effective binding agent onto the surface of each micro-particle which binds water prior to exposure of the colloidal crystal to water in order to render the micro-particle able to bind an initial water layer. Similarly, the metal (M) is preferably selected in part on the basis that the resulting metal oxide can bind a water layer thereon.

It will also be appreciated that the micro-particles do not have to be micro-spheres per se and may be of other shapes depending on the end application of the colloidal crystal. For example the micro-particles may be ellipsoid or rod shaped, hollow micro-spheres, core-shell structures of spheres, rods or ellipsoids.

The flow rate, the temperature (room temperature in the example disclosed herein but the method is not restricted to room temperature or atmospheric pressure) and the total duration of the treatment determine the thickness of the re-hydration layer, which will allow, in turn, the formation of a new silica layer by reacting again with SiCl₄ vapor. During this process, the silica deposited on the surface of adjacent micro-spheres causes them to overlap, thereby providing the mass continuity that is needed in order to use the silica colloidal crystals as templates for replicating the lattice, in the inverse colloidal crystal form but now with a vast range of different compositions. In order to accurately control the silica coating thickness, the flow rate and duration of each process is fixed and then repeated cyclically. For the samples presented in this example, N₂ gas was flown through a SiCl₄ or water containing bubbler, alternatively, at a flow rate between 50 ml/min and 200 ml/min during a time period that varied between 5 and 25 minutes for each SiCl₄ deposition treatment.

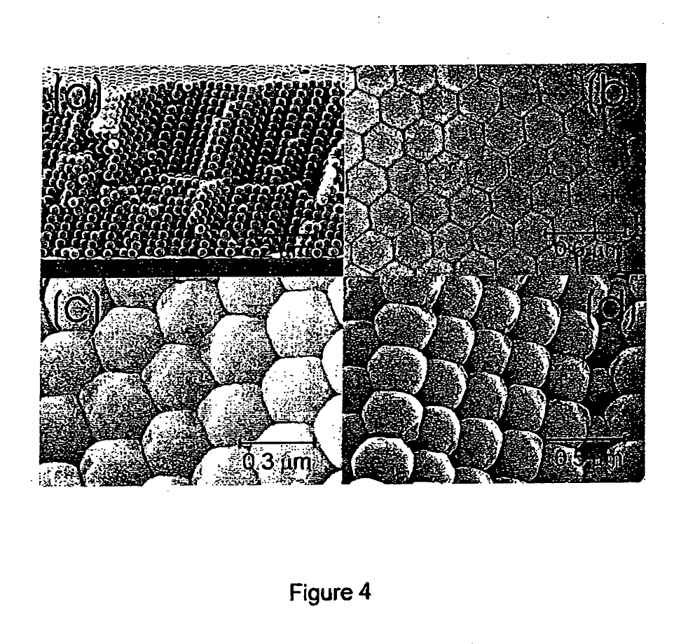

Scanning electron microscopy (SEM) was used to study the structural modifications induced by the present process of stabilizing the colloidal crystal and controlling the internal pore sizes between the micro-spheres. FIGS. 4(a) to 4(d) show scanning electron micrographs (SEM) of a planarized colloidal crystal made of 320 nm silica micro-spheres after being infiltrated with water vapour and a SiCl₄ using the layer-by-layer growth process disclosed herein. In this case, several deposition cycles were performed so that the external pores of the final sample were occluded. FIG. 4(a) shows a cleaved edge showing that the process of deposition and growth of the oxide layers does not disturb the long-range order of the structure. FIG. 4(b) shows detail of the external surface. FIG. 4(c) shows detail of a cleaved edge corresponding to a (111) plane of the structure. FIG. 4(d) shows the same as 4(c) for a (100) plane. The closing of the external pores occurs when the coating thickness reaches the value 1.155 D, where D is the diameter of the spheres. At this value the internal pores of the structure remain open although not interconnected any more.

The micrographs shown in FIGS. 4(a) to 4(d) clearly demonstrate that a high connectivity of the lattice is achieved without disturbing the long-range order of the lattice. The analysis of cleaved edges of the colloidal crystals allowed the homogeneity of the infiltration and the degree of micro-sphere overlapping resulting from the silica coating to be checked. A closer look at the structure reveals the dramatic changes in pore size resulting from the layer-by layer growth of silica. It is worth pointing out that in order to obtain similar degrees of necking between neighbouring particles by sintering, temperatures higher than 1000° C. must be employed, see H. Miguez, F. Meseguer, C. Lopez, A. Blanco, J. S. Moya, J. Requena, A. Mifsud, V. Fornes. Adv. Mater. 1998, 10, 480. An accurate control of the final coating thickness can be attained by the cyclic repetition of the process of infiltration and deposition of the oxide coating by controlling the amount of water present on the micro-sphere surfaces. In this regard, sample storage conditions (humidity and temperature) might induce changes in the moisture of the crystals and should therefore be taken into account.

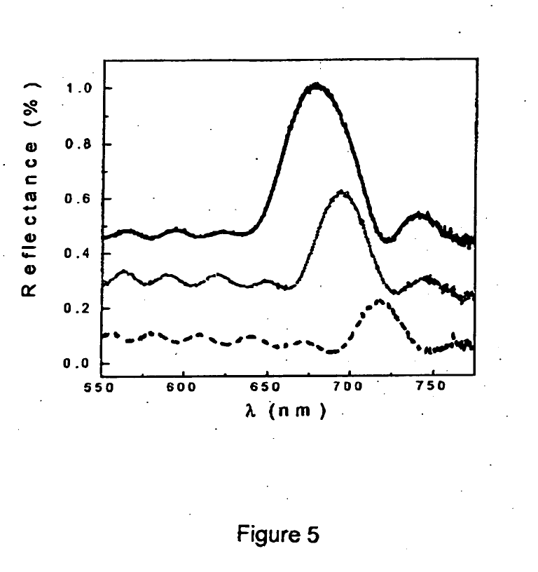

It is well known that the 3D ordering of sub-micrometer size colloids gives rise to diffraction of visible and near infrared light at wavelengths determined by the refractive index of the particles and the geometry of the arrangement. These optical properties are extremely sensitive to disorder or lack of homogeneity. Therefore, evidence of the uniformity of the silica coating should be observed in the optical properties of the colloidal crystals in which layers of silica have been grown on the colloidal micro-spheres. In FIG. 5 there are shown three spectra corresponding to a planarized silica colloidal crystal prior and after different degrees of silica infiltration. The spectral maximum detected corresponds to the diffraction coming from the (111) planes of the sample, while the side fringes are a consequence of the finite crystal size of the sample. Without wishing to be bound or limited by any theory or hypothesis, as silica is grown on the micro-spheres, a clear red-shift of the main peak is observed, which can be explained by the formula:
λ₍₁₁₁₎=2·d₍₁₁₁₎· [symbol] ε [symbol] (1)
where d₍₁₁₁₎ is the interplanar distance along the [111] direction and [symbol] ε [symbol] is the volume averaged dielectric constant of the composite: [symbol]
ε [symbol] =ff_{SiO}_{₂}·εₛ+(1−ff_{SiO}_{₂})·ε_{b} (2)
where ff_{SiO2} is the filling fraction of silica, and εₛ and ε_{b} are the dielectric constant of the micro-spheres and the background respectively. Thus gradually increasing the average refractive index in the structure as we increase the filling fraction of silica and close the air pores, keeping the lattice constant of the system unaltered. At the same time, both the decrease of the intensity and the narrowing of the peak are in good agreement with more complex theoretical photonic band structure calculations. In addition, the fine structure, that is, the secondary minima resulting from finite crystal size effects, remain after the infiltration. The agreement between theory and experiment regarding the evolution of the optical properties with the filling-fraction of silica, as well as the good optical quality of the infiltrated samples are proof of the uniformity of the silica coating achieved by the process proposed and shows explicitly the control of the optical properties achievable by the method herein presented.

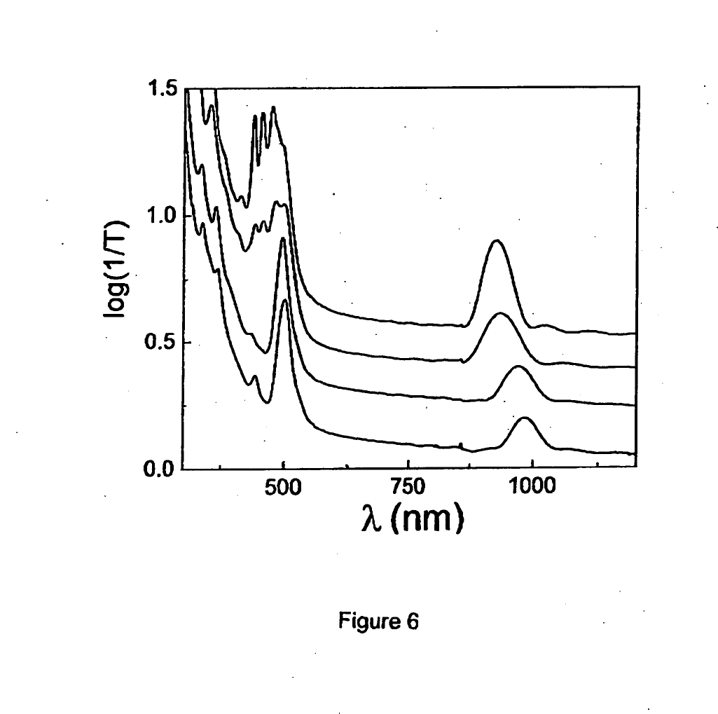

As a further example of the control of the optical properties of the silica colloidal crystals achievable by the silica deposition procedure described in this invention, the transmittance spectra of a planarized colloidal crystal made of spheres of around 400 nm diameter are shown in FIG. 6. In this case, attention is directed to the more complex peak structure observed at around 500 nm, which is due to optical propagation phenomena associated to the flat photonic band region of the structure. It can be clearly seen how a gradual modification of this peak structure can be realized by gradual deposition of a continuous layer of silica on the particle surface. Although details on the origin of, and applications derived from, these optical features corresponding to the flat band region are out of the scope of this invention, it is indeed a purpose of the present example and of the invention to show explicitly how oxide necking provides an accurate way of controlling the photonic crystal properties of colloidal crystals at also these flat band wavelength ranges.

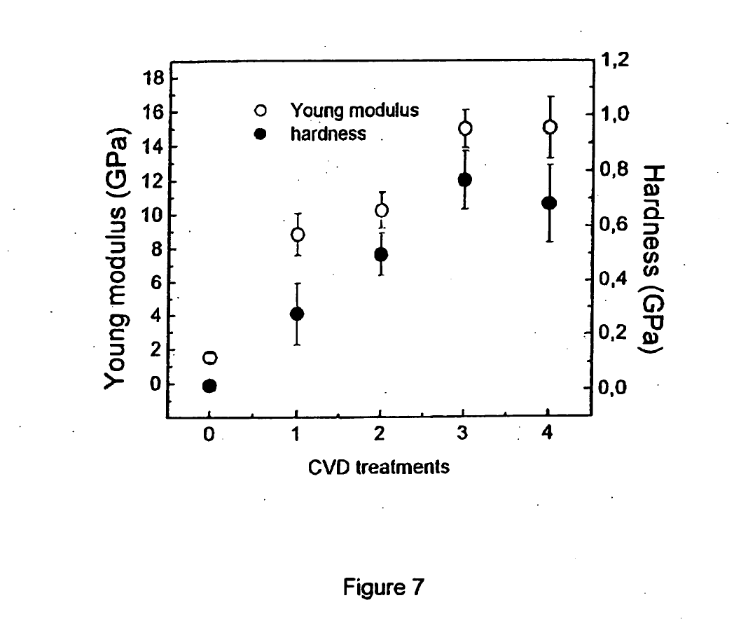

Regarding the mechanical properties of the necked samples, the Young modulus, or stiffness, and hardness of the same silica colloidal crystal after of growth of different numbers of oxide layers by alternating exposure to H₂O and SiCl₄ growth cycles, were estimated using depth-sensing nano-indentation. FIG. 7 shows a quantitative example of the large enhancement of the mechanical stability of a planarized silica colloidal crystal after being exposed to a different number of growth cycles. Both Young modulus and micro-hardness, as measured using a nano-indentation technique, are plotted versus the number of cycles. Based on the results plotted in FIG. 7, it can be seen that the stiffness increases from 1.5 GPa in the as-grown film up to 15 GPa after 4 growth cycle treatments, while the hardness changes from 0.01 GPa to 0.8 GPa. Typical values of these parameters for dense silica glass are 70 and 5.5 GPa respectively. Necking among the colloidal particles in the colloidal crystal as achieved using the method disclosed herein shows a dramatic effect on the mechanical properties of the colloidal crystal.

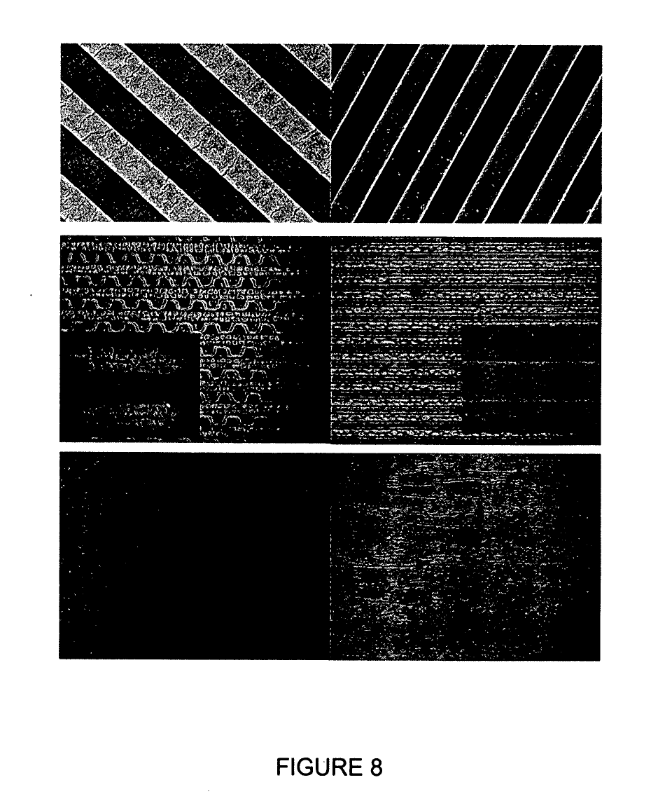

Finally, a comparison between the effect of sintering and that of oxide growth necking using the vapour deposition procedure described in the present invention on different confined and planarized colloidal crystal architectures clearly shows the much less occurrence of crackings when the second method is used. To illustrate this, FIG. 8 shows SEM and optical micrographs of different types of samples after sintering and after a silica coating treatment.

In conclusion, the present example provides a new method to control the pore size and enhance the connectivity of silica colloidal crystals. An atmospheric pressure layer-by-layer vapor deposition process performed at room temperature allows the growth of a continuous silica layer of controlled thickness interconnecting all the micro-spheres while maintaining unaltered the order and unit cell dimensions of the lattice. This method represents an alternative and general way to increase the mechanical stability of a colloidal crystal when sintering is not possible, or desirable, and is not limited to silica on silica micro-spheres but can be extended to micro-spheres and precursors of other compositions.

More particularly, the present example merely serves to exemplify the novel method to control the connectivity between the constituent silica micro-spheres of planarized and confined colloidal photonic crystals based on the vapor deposition of silicon tetrachloride on the surface of hydrated silica micro-spheres. The results disclosed herein provide evidence of the growth of a uniform layer of silica on top of each micro-sphere, as well as accurate control over the silica coating thickness. This implies a precise control of the filling fraction of the lattice and, consequently, of its optical properties, as it has been proved here. Furthermore, it has been shown that the newly grown, highly interconnected and hydrophilic silica micro-sphere surface is a suitable structure-directing template for the infiltration of for example silicon to create inverse silicon colloidal photonic crystal replicas. This necking method allows one to overcome most of the drawbacks arising from high temperature sintering processes, such as the cracking and contraction of the lattice. As it may be performed at room temperature, although not limited to room temperature, the method is compatible with the majority of substrates and it may be incorporated or retrofitted into current industrial fabrication processes of microelectronic devices. The necking process described herein is by no means limited to silica micro-sphere colloidal photonic crystals and also works well for polymer micro-sphere colloidal crystals and other precursors as discussed above (data not shown).

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A method of structurally stabilizing a colloidal crystal lattice and controlling pore size therein, the colloidal crystal being formed from micro-particles each having a surface to which water can be hydrogen bonded, the method comprising the steps of:
a) infiltrating water into the colloidal crystal lattice so that water is hydrogen bonded to an outer surface of the micro-particles;
b) infiltrating into the colloidal crystal lattice a reactive fluid containing a metal atom M for an effective period of time, the reactive fluid being reactive in the presence of water, wherein said effective period of time is sufficient so that the hydrogen bonded water reacts with the reactive fluid to form a continuous metal oxide layer on each micro-particle in the lattice; and
c) repeating steps a) and b) a pre-selected number of times to give a metal oxide layer on the micro-particles with a pre-selected thickness so that the metal oxide layer deposited on the surface of adjacent micro-particles overlaps thereby providing mass continuity between neighbouring micro-particles to structurally stabilize the colloidal crystal lattice and control the pore size in the colloidal crystal lattice between the micro-particles.

2. The method according to claim 1 wherein the micro-particles are substantially mono-disperse micro-spheres, and the reactive fluid is a reactive gas.

3. The method according to claim 2 wherein the micro-spheres have a diameter in a range from about 200 nm to about 5000 nm.

4. The method according to claim 2 wherein the micro-spheres are silica micro-spheres and wherein the surface of the silica micro-spheres includes silanol functional groups, which can form hydrogen bonds with water.

5. The method according to claim 4 wherein said reactive gas containing a metal atom (M) is a gas containing silicon so that said metal atom is silicon and wherein said metal oxide is silica (SiO₂).

6. The method according to claim 5 wherein gas containing silicon is SiCl₄, and wherein the water bound to said silica micro-spheres in the colloidal crystal lattice reacts with the SiCl₄ to form silica (SiO₂).

7. The method of depositing according to claim 2 wherein said colloidal crystal lattice is exposed to the water vapor and the gas at substantially room temperature and substantially atmospheric pressure.

8. The method according to claim 2 wherein the water vapor and the reactive gas are flowed with a substantially inert carrier gas into a chamber containing said colloidal crystal lattice.

9. The method according to claim 8 wherein said step of exposing the colloidal crystal lattice to the reactive gas includes flowing the reactive gas through a septum means to provide homogeneity of the reactive gas in the chamber.

10. The method according to claim 1 wherein said metal M is selected to give a metal oxide which binds water either by chemisorption or physisorption.

11. The method according to claim 10 wherein said metal M is selected from the group consisting of silicon (Si), germanium (Ge), tin (Sn) and titanium (Ti).

12. The method according to claim 2 wherein said micro-spheres comprise polymer micro-spheres.

13. The method according to claim 1 wherein said fluid is a liquid containing the reactive metal.

14. The method according to claim 1 including a step of depositing an effective binding agent onto a surface of each micro-particle which binds water prior to exposure of said colloidal crystal to water in order to render said micro-particle able to bind an initial water layer.

15. The method according to claim 1 wherein said micro-particles have one of a spherical shape, ellipsoidal shape and rod shape.

16. The method according to claim 1 including purging excess water which is not hydrogen bonded to the micro-particles from the colloidal crystal after step a) prior to step b).

17-36. (canceled)
